(19) United States
(12) Patent Application Publication
(10) Pub. No.: US 2015/0116993 A1
(43) Pub. Date: Apr. 30, 2015

(54) LED WORK LAMP

(71) Applicant: LUC-POWER ELECTRONICS CO., LTD., Jiangsu (CN)

(72) Inventor: YANG LUO, JIANGSU (CN)

(73) Assignee: LUC-POWER ELECTRONICS CO., LTD., Jiangsu (CN)

(21) Appl. No.: 14/061,916

(22) Filed: Oct. 24, 2013

(51) Int. Cl. F21V 3/00; F21V 21/08; F21L 4/00

(52) U.S. Cl. CPC F21V 3/005; F21L 4/00; F21V 21/0832
USPC 362/186

(57) ABSTRACT

An LED work lamp comprises a hook, a cap, a lamp hood, a lamp plate, a transparent hood, a battery chamber, a battery, and a handle. The hook and the cap are disposed closely at one end of the lamp hood. One end of the hook is located in the cap. The lamp plate is located inside the lamp hood. The transparent hood is located at the upper part of the lamp hood. The battery is located at the other end of the lamp hood. The battery chamber is located below the lamp hood. The handle is disposed around the outer surface of the battery chamber. The present invention has the advantages of the simplicity and convenience in changing the transparent hood and fast heat dissipation.

### FIELD OF THE INVENTION

The present invention relates generally to a light source, and particularly to an LED work lamp.

### BACKGROUND OF THE INVENTION

Palm-size LED work lamps have the advantages of repeated usage, convenient portability, and high brightness. Thereby, they are applied extensively in repairing trades.

The application environment of LED work lamp is relative harsh. The transparent parts such as lens are easily contamination by greasy dirt, which reduces the brightness of the work lamp and resulting in uselessness of the lamp. Most palm-size work lamps adopt plastic materials as the housing of lamps. The housing covers LED light sources completely and forming a relatively airtight environment. Nonetheless, as the number of LEDs and the currents increase, the temperature of inside of the lamps raises abruptly. The heat is hard able to be dissipated effectively. Being used the work lamps in such an environment, the lifetime of the work lamp will be shortened drastically.

### SUMMARY

According to the drawback of difficulty in changing the transparent hood in the palm-size LED work lamps according to the prior art, the present invention provides a novel LED work lamps having the advantages of the simplicity and convenience in changing the transparent hood and the faster heat dissipation.

For achieving the objective described above, the present invention provides the following technical solution.

The present invention provides an LED work lamp, which comprises a hook, a cap, a lamp hood, a lamp plate, a transparent hood, a battery chamber, a battery, and a handle. The hook and the cap are disposed closely at one end of the lamp hood. One end of the hook is located in the cap. The lamp plate is located inside the lamp hood. The transparent hood is located at the upper part of the lamp hood. The battery is located at the other end of the lamp hood. The battery chamber is located below the lamp hood. The handle is disposed around the outer surface of the battery chamber.

Preferably, the LED lamp according to the present invention further comprises a first inner plug located inside the cap and at one end inside the lamp hood. The first inner plug is connected with the lamp hood via a screw.

Preferably, the material of the lamp hood is aluminum.

Preferably, the lamp hood has two grooves therein and opposite to each other, including a middle groove and a top groove. The lamp plate is located in the middle groove inside the lamp hood; the transparent hood is located in the top groove at the upper part of the lamp hood.

Preferably, the lamp hood has holes at the bottom part.

Preferably, the transparent hood is a PC sheet.

Preferably, the battery chamber has two bumps therein for mating the lamp hood.

Preferably, the LED work lamp further comprises a fixing handle lining located on the top surface outside the lamp hood.

Preferably, the handle lining has a cylindrical bolt outside for positioning the battery. The handle lining has holes corresponding to the light sources on the lamp plate.

Preferably, the length of the handle is smaller than the length of the lamp hood.

Preferably, the handle has a clamping loop at an end.

Preferably, the lamp plate has COB LED light sources or SMD LED light sources.

Preferably, the lamp hood has two grooves therein including a middle groove and a top groove. The middle groove has its opening opposite to each other. The top groove has its opening in the vertical direction. The lamp plate is located inside the lamp hood.

Preferably, the LED further comprises a support chamber used for supporting the lamp plate.

Preferably, the LED work lamp further comprises a first inner plug and a second inner plug located inside the cap. One end of the lamp hood is located inside the first and second inner plugs. The first and second inner plugs are connected with the lamp hood via a screw.

Compared with the technology according to the prior art, the present invention has the following advantages and benefits:
1. The present invention solves the problem of difficulty in changing the transparent hood in palm-size LED work lamps according to the prior art and makes changing of the transparent hood simple and convenient.
2. The present invention adopts a structure composed by half aluminum and half transparent member and makes good use of the high heat dissipation coefficient of aluminum material. Thereby, the problem of difficulty in dissipating heat inside the work lamp can be solved effectively and thus increasing significantly the lifetime of the work lamp.

### BRIEF DESCRIPTION OF THE DRAWINGS

FIG. 1 shows an exploded view of the LED work lamp according the first embodiment of the present invention;

FIG. 2 shows an exploded view of the LED work lamp according the second embodiment of the present invention;

FIG. 3 shows an exploded view of the LED work lamp according the third embodiment of the present invention;

FIG. 4 shows a first schematic diagram of changing the transparent hood of the LED work lamp according to the present invention;

FIG. 5 shows a second schematic diagram of changing the transparent hood of the LED work lamp according to the present invention; and

FIG. 6 shows a third schematic diagram of changing the transparent hood of the LED work lamp according to the present invention.

### DETAILED DESCRIPTION

In order to make the structure and characteristics as well as the effectiveness of the present invention to be further understood and recognized, the detailed description of the present invention is provided as follows along with embodiments and accompanying figures.

### First Embodiment

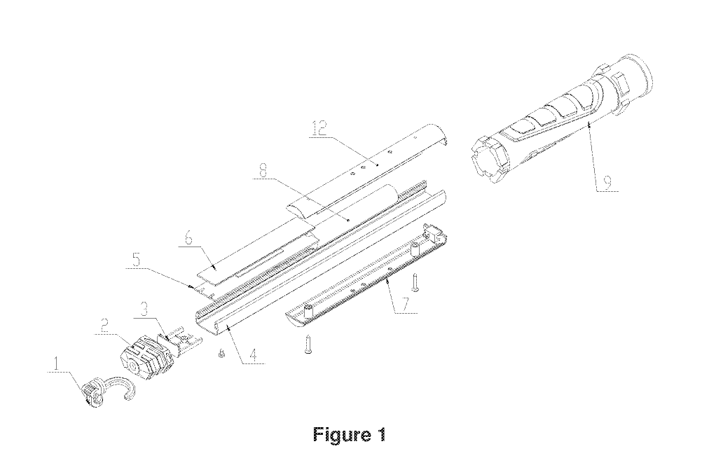

As shown in FIG. 1, which shows an exploded view of the LED work lamp according the first embodiment of the present invention.

An LED work lamp comprises a hook 1, a cap 2, a lamp hood 4, a lamp plate 5, a transparent hood 6, a battery chamber 7, a battery 8, and a handle 9. The hook 1 and the cap 2 are disposed closely at one end of the lamp hood 4. One end of the hook 1 is located in the cap 2. The lamp plate 5 is located inside the lamp hood 4. The transparent hood 6 is located at the upper part of the lamp hood 4. The battery 8 is located at the other end of the lamp hood 4. The battery chamber 7 is located below the lamp hood 4. The handle 9 is disposed around the outer surface of the battery chamber 7.

The LED lamp further comprises a first inner plug 3 located inside the cap 2 and at one end inside the lamp hood 4. The first inner plug 3 is connected with the lamp hood 4 via a screw.

The LED work lamp further comprises a fixing handle lining 12 located on the top surface outside the lamp hood 4. The handle lining 12 has a cylindrical bolt outside for positioning the battery 8. The handle lining 12 has holes corresponding to the light sources on the lamp plate 5.

The material of the lamp hood 4 is aluminum. The lamp hood 4 has two grooves therein and opposite to each other, including a middle groove and a top groove. The lamp plate 5 is located in the middle groove inside the lamp hood 4; the transparent hood 6 is located in the top groove at the upper part of the lamp hood 4. The lamp hood 4 has holes at the bottom part.

The transparent hood 6 is a PC sheet. The battery chamber 7 has two bumps therein for mating the lamp hood 4. The handle 9 has a clamping loop at an end. The lamp plate 5 has COB LED light sources or SMD LED light sources.

The length of the handle 9 is smaller than the length of the lamp hood 4. The lamp hood 4 maintains a certain exposed area for facilitating heat dissipation.

### Second Embodiment

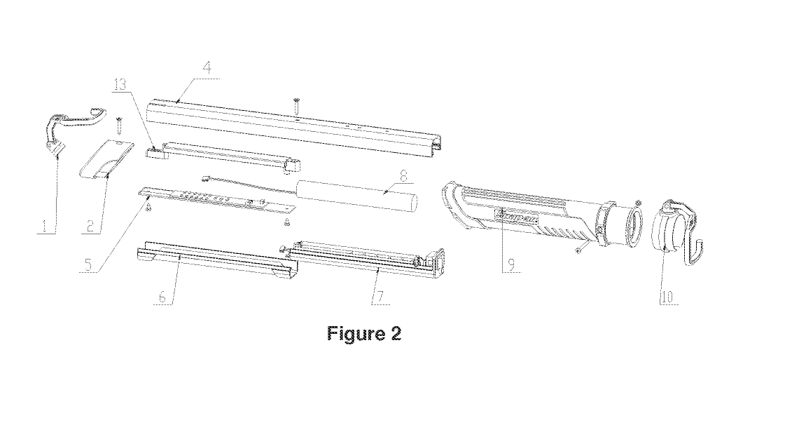

As shown in FIG. 2, which shows an exploded view of the LED work lamp according the second embodiment of the present invention.

An LED work lamp comprises a hook 1, a cap 2, a lamp hood 4, a lamp plate 5, a transparent hood 6, a battery chamber 7, a battery 8, and a handle 9. The hook 1 and the cap 2 are disposed closely at one end of the lamp hood 4. One end of the hook 1 is located in the cap 2. The lamp plate 5 is located inside the lamp hood 4. The transparent hood 6 is located at the upper part of the lamp hood 4. The battery 8 is located at the other end of the lamp hood 4. The battery chamber 7 is located below the lamp hood 4. The handle 9 is disposed around the outer surface of the battery chamber 7. The material of the transparent hood 6 is PC.

The material of the lamp hood 4 is aluminum. The lamp hood 4 has two grooves therein including a middle groove and a top groove. The middle groove has its opening opposite to each other. The top groove has its opening in the vertical direction. The lamp plate 5 is located inside the lamp hood 4. The LED work lamp further comprises a supporting chamber 13 used for supporting the lamp plate 5. The lamp hood 4 has holes at the bottom part.

The handle 9 has a clamping loop at an end. The lamp plate 5 has COB LED light sources or SMD LED light sources.

The length of the handle 9 is smaller than the length of the lamp hood 4. The lamp hood 4 maintains a certain exposed area for facilitating heat dissipation.

### Third Embodiment

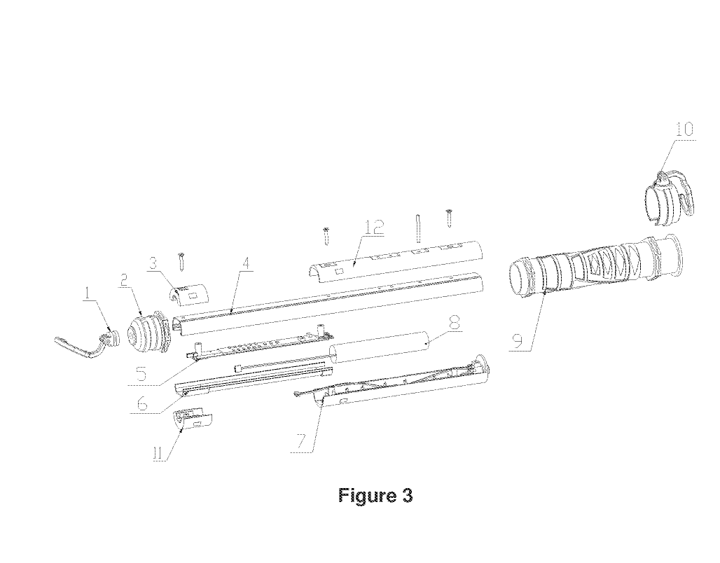

As shown in FIG. 3, which shows an exploded view of the LED work lamp according the third embodiment of the present invention.

An LED work lamp comprises a hook 1, a cap 2, a lamp hood 4, a lamp plate 5, a transparent hood 6, a battery chamber 7, a battery 8, and a handle 9. The hook 1 and the cap 2 are disposed closely at one end of the lamp hood 4. One end of the hook 1 is located in the cap 2. The lamp plate 5 is located inside the lamp hood 4. The transparent hood 6 is located at the upper part of the lamp hood 4. The battery 8 is located at the other end of the lamp hood 4. The battery chamber 7 is located below the lamp hood 4. The handle 9 is disposed around the outer surface of the battery chamber 7. The material of the transparent hood 6 is PC.

The LED work lamp further comprises a first inner plug 3 and a second inner plug 11 located inside the cap 2. One end of the lamp hood 4 is located inside the first and second inner plugs 3, 11. The first and second inner plugs 3, 11 are connected with the lamp hood 4 via a screw.

The material of the lamp hood 4 is aluminum. The lamp hood 4 has two grooves therein including a middle groove and a top groove. The middle groove has its opening opposite to each other. The top groove has its opening in the vertical direction. The lamp plate 5 is located inside the lamp hood 4.

The LED work lamp further comprises a handle lining 12 located on the top surface outside the lamp hood 4. The handle lining 12 has a cylindrical bolt outside for positioning the battery 8. The handle lining 12 has holes corresponding to the light sources on the lamp plate 5.

The handle 9 has a clamping loop at an end. The lamp plate 5 has COB LED light sources or SMD LED light sources.

The length of the handle 9 is smaller than the length of the lamp hood 4. The lamp hood 4 maintains a certain exposed area for facilitating heat dissipation.

The present invention solves the problem of difficulty in changing the transparent hood in palm-size LED work lamps according to the prior art and makes changing of the transparent hood simple and convenient.

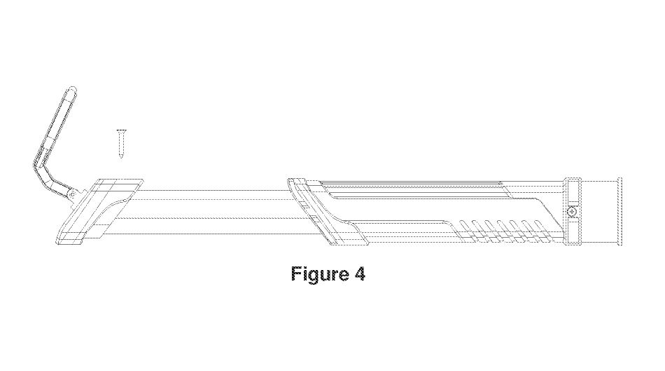

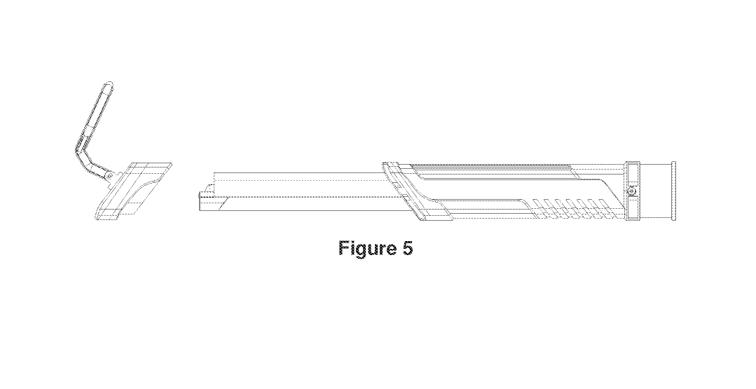

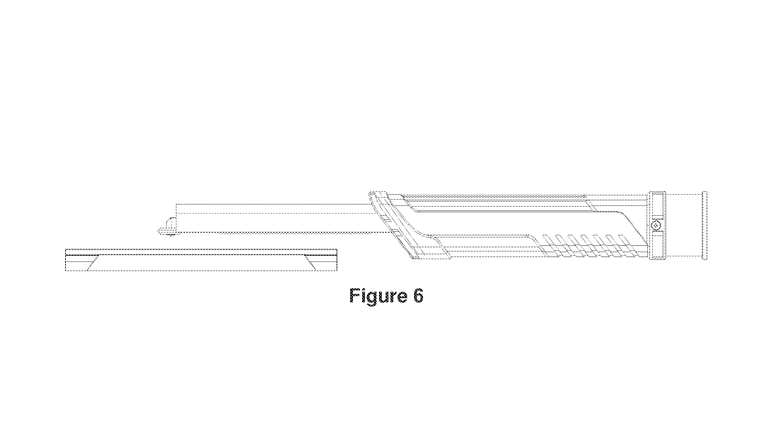

FIG. 4 shows a first schematic diagram of changing the transparent hood of the LED work lamp according to the present invention; FIG. 5 shows a second schematic diagram of changing the transparent hood of the LED work lamp according to the present invention; and FIG. 6 shows a third schematic diagram of changing the transparent hood of the LED work lamp according to the present invention. The steps for changing the transparent hood 6 are simple and rapid, and comprise unscrewing the screw used for fixing the cap 2 (as shown in FIG. 4), uncapping the cap (as shown in FIG. 5), and changing the transparent hood 6 (as shown in FIG. 6).

The present invention adopts a structure composed by half aluminum and half transparent member and makes good use of the high heat dissipation coefficient of aluminum material. Thereby, the problem of difficulty in dissipating heat inside the work lamp can be solved effectively and thus increasing significantly the lifetime of the work lamp.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An LED work lamp, comprising a hook, a cap, a lamp hood, a lamp plate, a transparent hood, a battery chamber, a battery, and a handle; said hook and said cap disposed closely at one end of said lamp hood; one end of said hook located in said cap; said lamp plate located inside said lamp hood; said transparent hood located at the upper part of said lamp hood; said battery located at the other end of said lamp hood; said battery chamber located below said lamp hood; and said handle disposed around the outer surface of said battery chamber.

2. The LED work lamp of claim 1, wherein said LED lamp further comprises a first inner plug, located inside said cap and at one end inside said lamp hood, and connected with said lamp hood via a screw.

3. The LED work lamp of claim 1, wherein the material of said lamp hood is aluminum; said lamp hood has two grooves therein and opposite to each other, including a middle groove and a top groove; said lamp plate is located in said middle groove inside said lamp hood; said transparent hood is located in said top groove at the upper part of said lamp hood; and said lamp hood has holes at the bottom part.

4. The LED work lamp of claim 2, wherein the material of said lamp hood is aluminum; said lamp hood has two grooves therein and opposite to each other, including a middle groove and a top groove; said lamp plate is located in said middle groove inside said lamp hood; said transparent hood is located in said top groove at the upper part of said lamp hood; and said lamp hood has holes at the bottom part.

5. The LED work lamp of claim 1, wherein said transparent hood is a PC sheet; said battery chamber has two bumps therein for mating said lamp hood; a fixing handle lining is located on the top surface outside said lamp hood; and the length of said handle is smaller than the length of said lamp hood.

6. The LED work lamp of claim 5, wherein said handle lining has a cylindrical bolt outside for positioning said battery; and said handle lining has holes corresponding to the light sources on said lamp plate.

7. The LED work lamp of claim 1, wherein said handle has a clamping loop at an end.

8. The LED work lamp of claim 1, wherein said lamp plate has COB LED light sources or SMD LED light sources.

9. The LED work lamp of claim 1, wherein said lamp hood has two grooves therein including a middle groove and a top groove; said middle groove has its opening opposite to each other; said top groove has its opening in the vertical direction; and said lamp plate is located inside said lamp hood.

10. The LED work lamp of claim 1, wherein said LED work lamp further comprises a supporting chamber used for supporting said lamp plate.

11. The LED work lamp of claim 1, wherein said LED work lamp further comprises a first inner plug and a second inner plug located inside said cap; one end of said lamp hood is located inside said first inner plug and said second inner plug; and said first inner plug and said second inner plug are connected with said lamp hood via a screw.
